(19) United States
(12) Patent Application Publication
(10) Pub. No.: US 2013/0333624 A1
(43) Pub. Date: Dec. 19, 2013

(54) Base, Container and Procedure for Collecting Waste from an Automatic Self Cleaning Litter Box into a Bag or Container

(71) Applicant: Michael John Edgar, Florence, AZ (US)

(72) Inventor: Michael John Edgar, Florence, AZ (US)

(73) Assignee: Kelea Michele Nevis, Florence, AZ (US)

(21) Appl. No.: 13/738,505

(22) Filed: Jan. 10, 2013

Related U.S. Application Data
(60) Provisional application No. 61/659,963, filed on Jun. 14, 2012.

(51) Int. Cl. A01K 1/01

(52) U.S. Cl. CPC A01K 1/01
USPC 119/161

(57) ABSTRACT

This invention consists of a base and container which together produce a more expedient and sanitary process for collecting and disposing waste accumulated in the holder/tray of a self cleaning litter box. This device utilizes waste being collected into any bag inserted into the container rather than the accrual of waste in the smaller and more costly holders. Increased capacity lowers frequency of disposal reducing unhealthy conditions present when pet waste exceeds the capacity of the litter box holder. This invention can be made to accommodate more than one size of an automatic self cleaning litter box. The base would be positioned underneath the litter box and the container for collecting waste located adjacent to the self cleaning rake so waste falling from the litter box rake would be guided into a bag positioned within the container; which is shaped to substitute for the more expensive holder.

### CROSS-REFERENCE TO RELATED APPLICATIONS

Provisional Patent Application No. 61/659,963

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable.

### BACKGROUND OF THE INVENTION

The base and container (the invention) for automatic litter machines allows for single cat or multiple cat applications.

The invention allows utilization of common grocery or other waste receptacle bags for capturing litter from automatic litter machines.

### BRIEF SUMMARY OF THE INVENTION

This automatic litter machine base and litter capturing container will hold more waste than prior devices.

This allows for less maintenance and emptying of litter. It can utilize existing common grocery bags placed within the container for capturing litter. This will cut down on the waste entering landfills. This will reduce the carbon imprint on the earth.

The automatic litter machine base and container can be made from any of several materials not limited to woods, plastics, acrylics, or any other such materials with equivalent rigidity.

### BRIEF DESCRIPTION OF THE DRAWINGS

FIG. 1. FIG. 1 shows an Isometric view of the base displaying front and side hand holds as well as the container and the opening into which it fits.

FIG. 2. FIG. 2 illustrates another Isometric view of the base displaying side and rear hand holds as well as the container and the opening into which it fits.

FIG. 3. FIG. 3 presents the top view of the base including the front, rear and both side hand holds as well as the container inserted into its opening.

FIG. 4. FIG. 4 is a two dimensional view of the side of the base which shows the front, rear and side hand holds and a side view of the container.

FIG. 5. FIG. 5 shows a cross section two dimensional view of the base displaying the hand hold and the lip around the outside edge of the base for stability and the cross section of the container.

FIG. 6. FIG. 6 presents a two dimensional front view of the base including the front and side hand holds as well as a front view of the container.

FIG. 7. FIG. 7 demonstrates a two dimensional front view of the base, including the front and side hand holds, as well as the container which is located as it would be in its final installation. Once the container has been inserted into its opening in the base, the bottom of said container will be seated upon any surface, i.e.: floor, table, bench, on which the base is located.

FIG. 8. FIG. 8 illustrates the final two dimensional view of the base, hand holds and container as it would appear seated within its opening in the base. The automatic litter machine would rest atop the base with the front of the machine abutted to the container. The base is long enough to enable an operator to slide the self cleaning litter machine back away from the container which allows the operator to remove the bag which was inserted into the container to collect the waste from the self cleaning litter machine.

### DETAILED DESCRIPTION AND BEST MODE OF IMPLEMENTATION

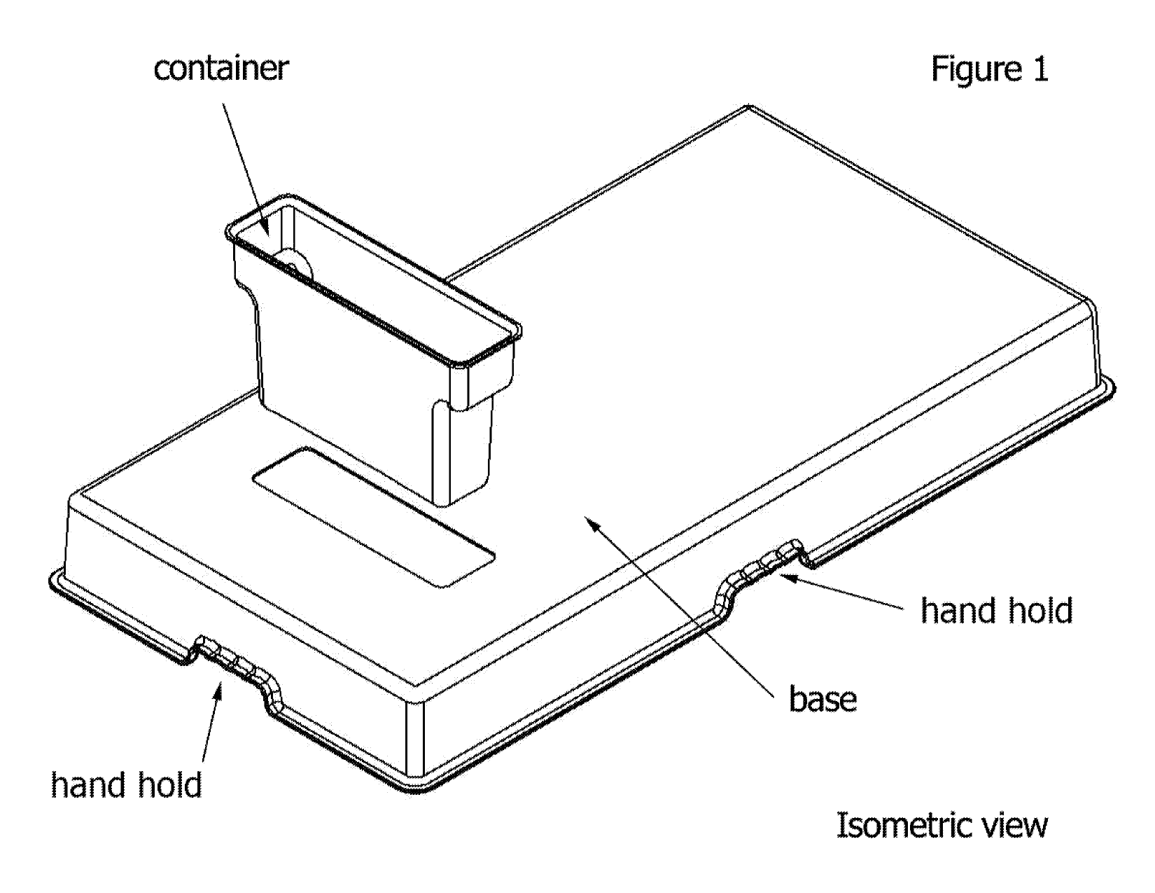

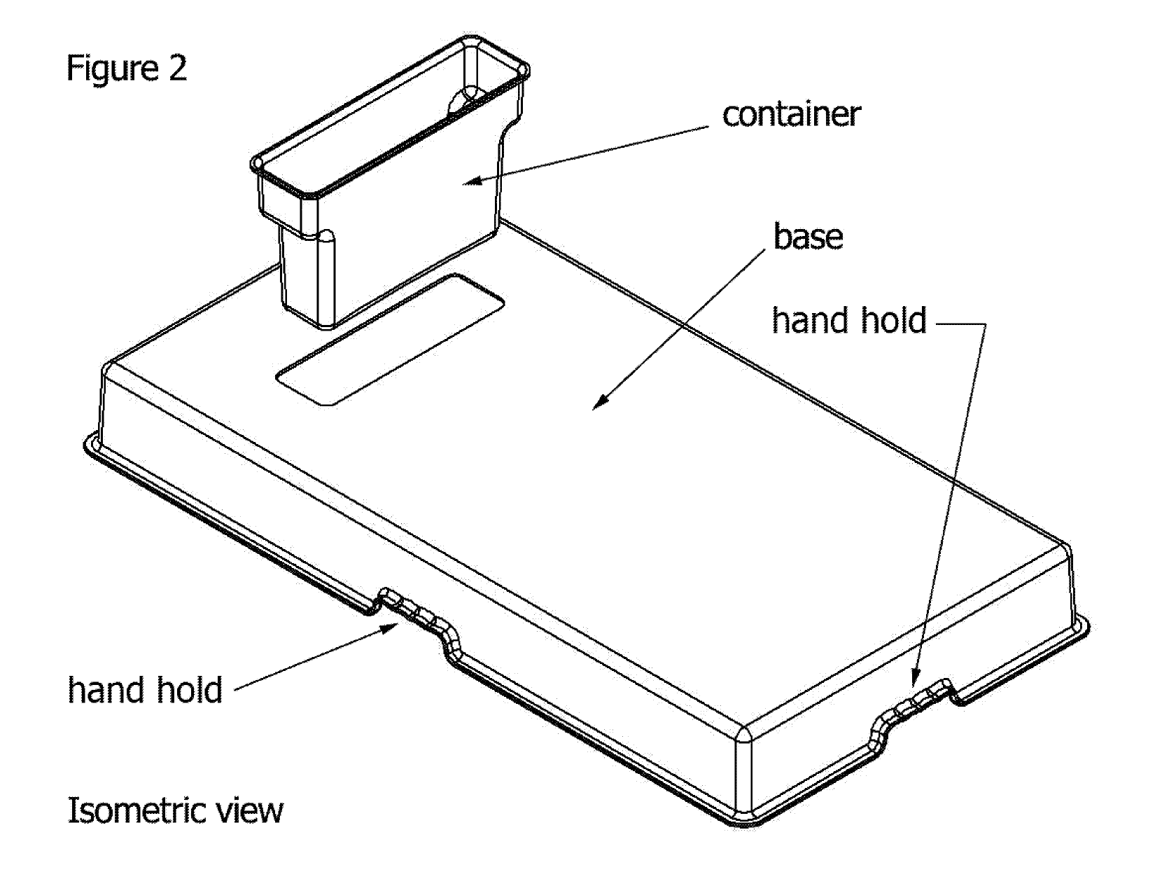

Referring now to the invention in more detail, in FIG. 1 and FIG. 2, a base is presented that when made, in an appropriate shape, size and configuration, it will allow an automatic litter machine to sit on its top plane.

FIG. 1 and FIG. 2 also shows the container. This container is designed to fit into the opening on the top plane of the base.

In further detail, still referring to the invention depicted in FIGS. 1 and 2, three of the four hand holds are shown; one at the front, rear and on each side. The two hand holds on either side are used for picking up the entire invention and the automatic litter machine. The front hand hold can be used while pushing the machine away from the container for ease of emptying said container. The hand hold on the rear can be used to hold onto the base while pulling the machine toward the rear of the base, again, for ease of emptying the container.

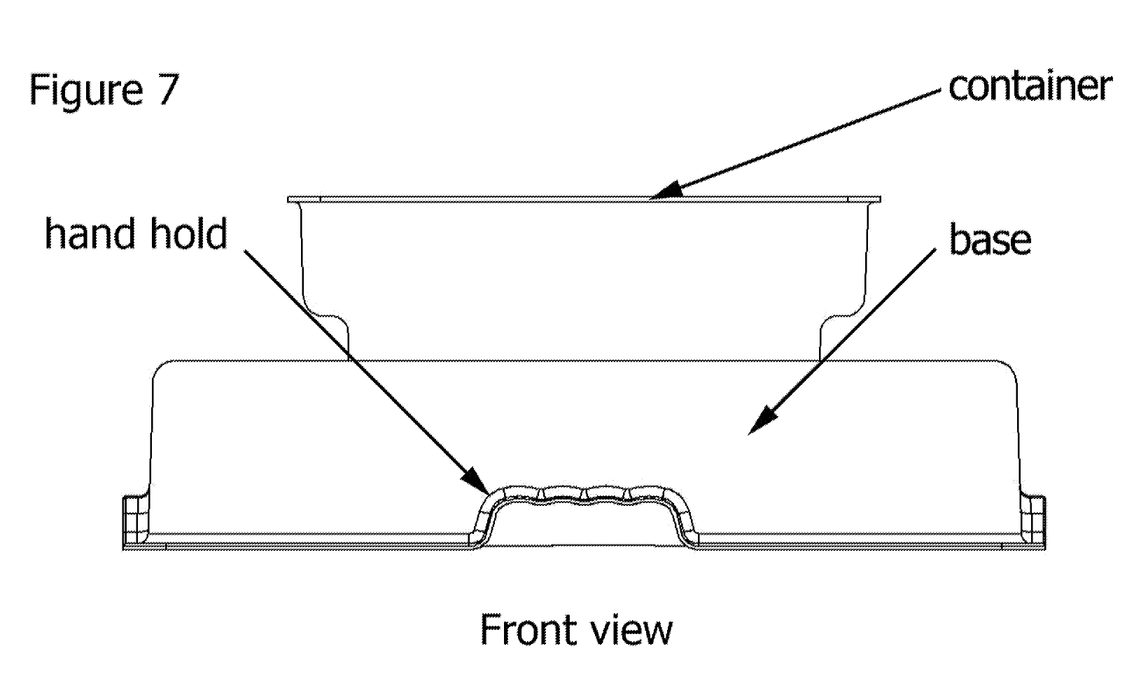

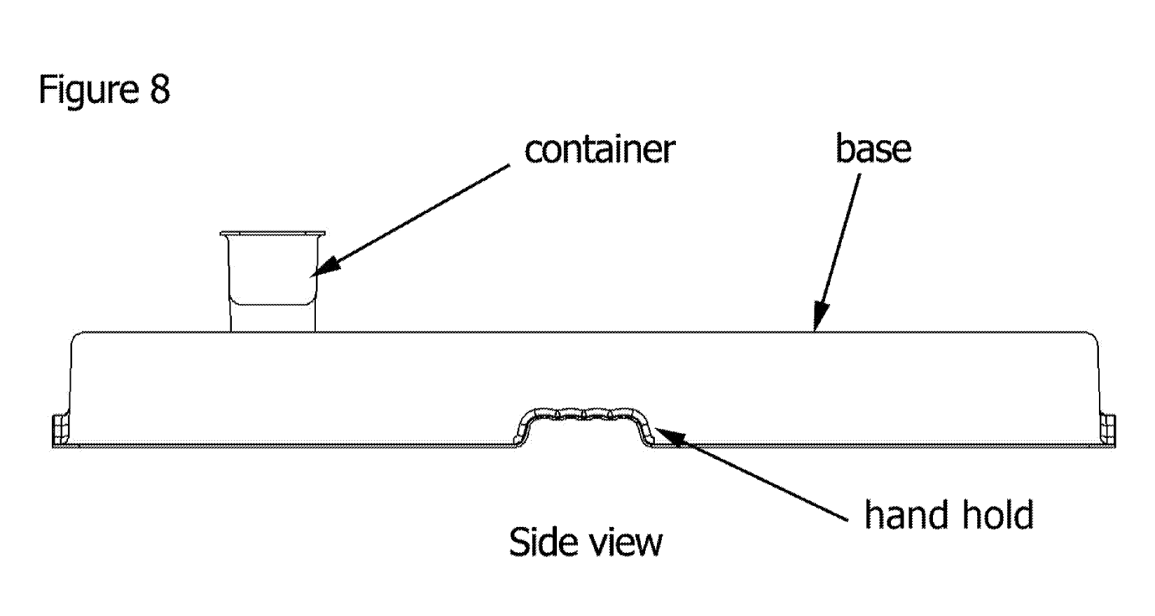

FIGS. 7 and 8 show the base with the container inserted. The automatic self cleaning litter box would sit atop the base with the front of said machine butted up to the container. The container would hold any manner of bag into which the rake from the self cleaning litter box would shovel waste.

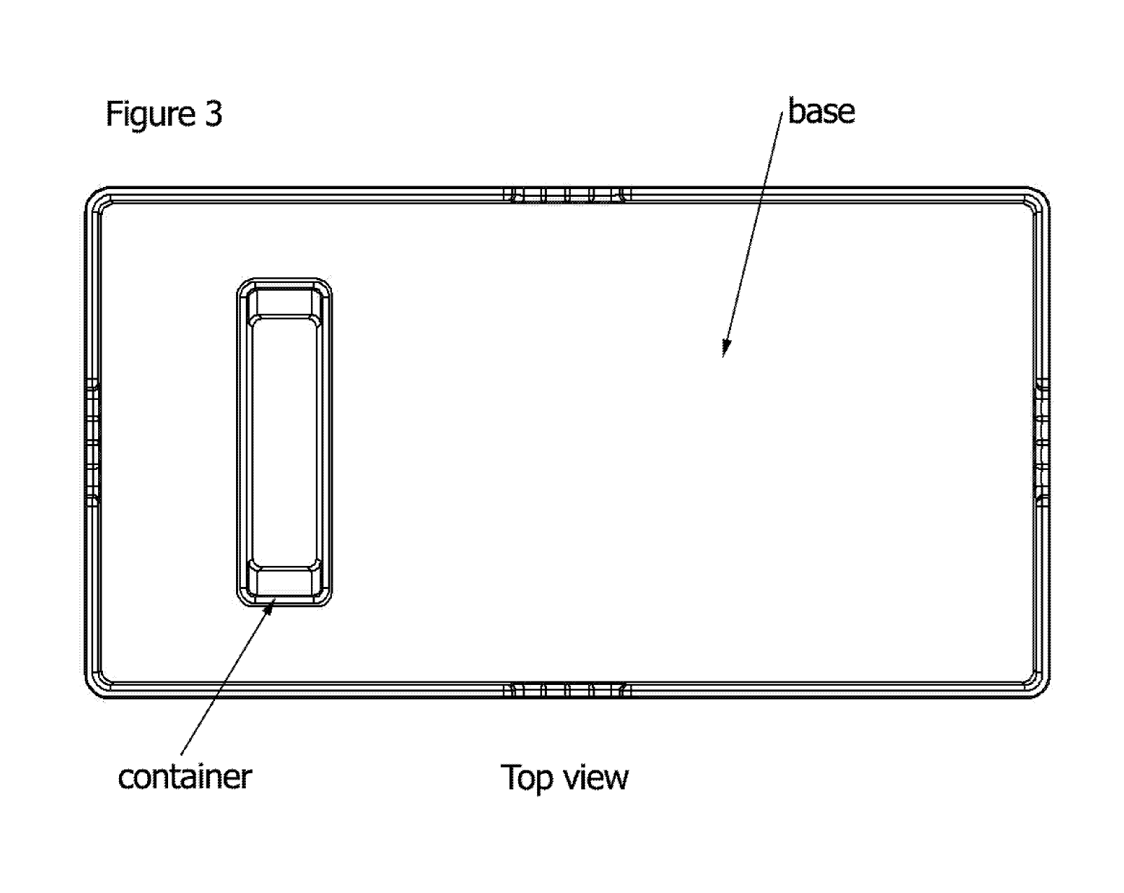

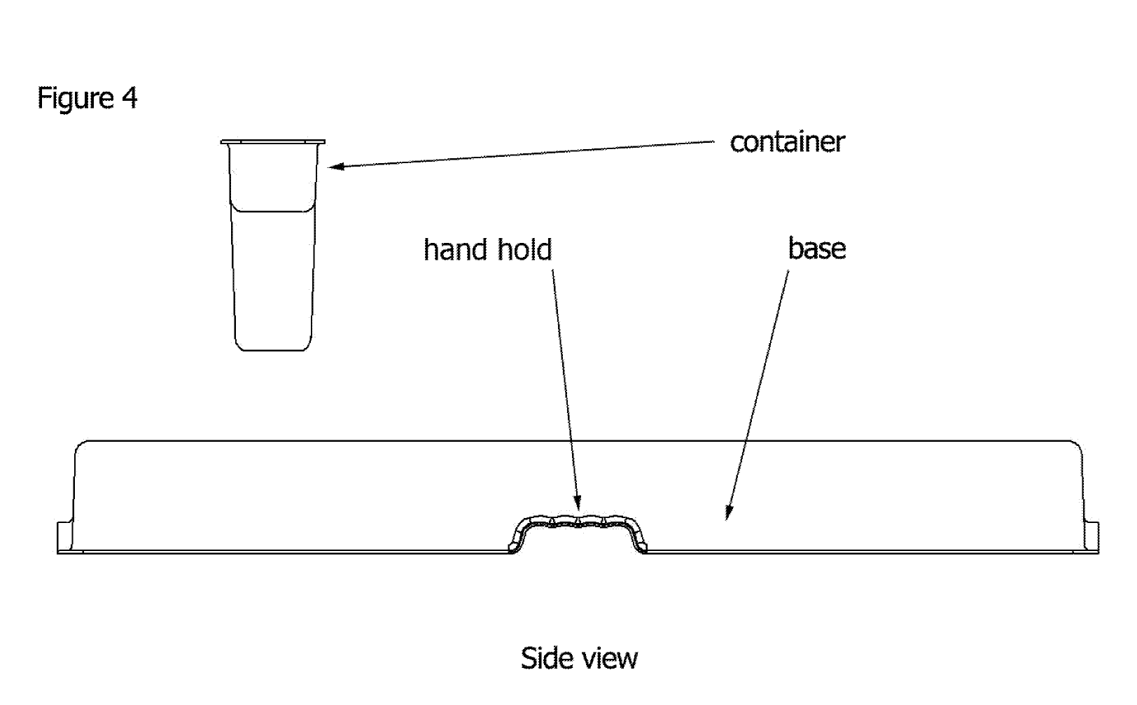

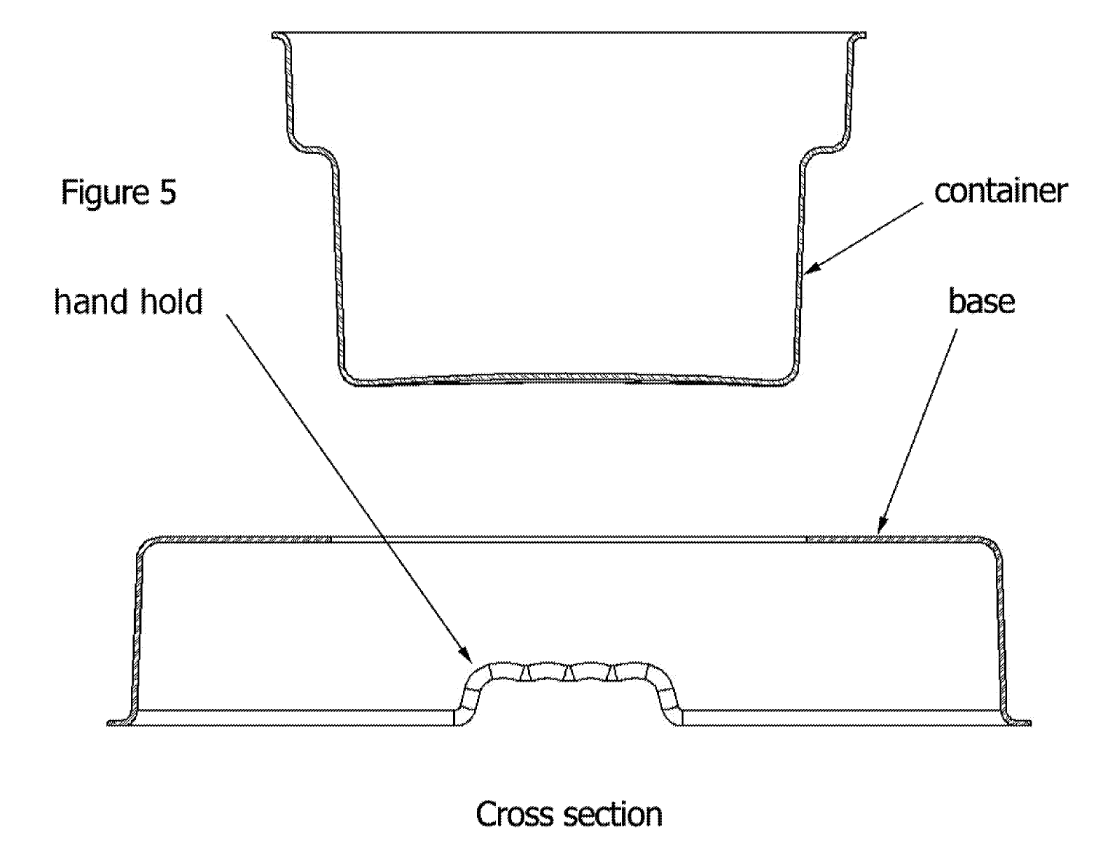

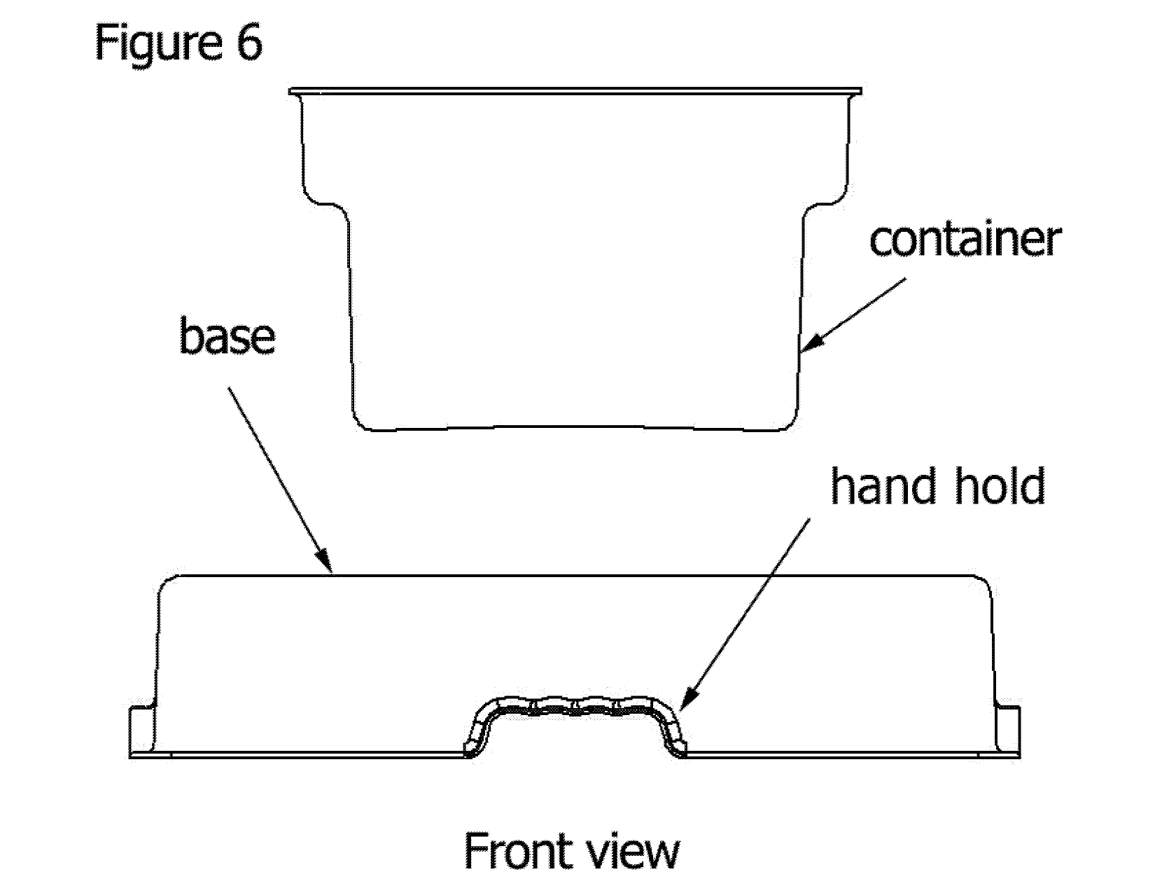

FIGS. 1-8 show different perspectives of the container. When any bag i.e. plastic grocery bag is inserted into the container it will collect approximately three times the amount of waste, as what is typically collected in the trays provided by the self cleaning litter box manufacturers, and using these bags will be at no cost or very minimal cost to the consumer.

The construction details of the invention as shown in FIGS. 1 and 2 are that the invention may be made of wood or of any other sufficiently rigid and strong material such as plastic, metal and the like. Further, the two components of this invention being base and container can be made of different materials.

The advantages of the present invention include without limitation that it is portable and exceedingly easy to transport. Since the base and container are relatively lightweight the invention could be moved by a single person. Further the devices would pass through doorways without any widening and are easily moved from spot to spot once they are inside a room.

In broad embodiment, the present invention would be seated on the floor, whether it is wood, linoleum, tile, carpet, or the likes, or on a table, or any other solid surface. The automatic self cleaning litter box would be set upon this base.

While the foregoing written description of the invention enables one of ordinary skill to make and use what is considered presently to be the best mode thereof, those of ordinary skill will understand and appreciate the existence of variations, combinations and equivalents of the specific embodiment, method, and examples herein. The invention should therefore not be limited by the above described embodiment, method, and examples, but by all embodiments and methods within the scope and spirit of the invention as claimed.

### REFERENCES (Incorporated Herein by Reference)

Not Applicable.

1. A platform which is constructed to hold a waste collecting container and upon which an automatic self cleaning litter box machine is meant to be placed so that the self cleaning litter box rake mechanism will channel waste into said container or bag inserted therein.
